(19) United States
(12) Patent Application Publication
(10) Pub. No.: US 2010/0111820 A1
(43) Pub. Date: May 6, 2010

(54) METHOD OF DETERMINING LASER STABILITIES OF OPTICAL MATERIAL, CRYSTALS OBTAINED WITH SAID METHOD, AND USES OF SAID CRYSTALS

(76) Inventors: Ute Natura, Jena (DE); Lutz Parthier, Kleinmachnow (DE); Johann-Christoph Von Saldern, Jena (DE)

Correspondence Address: MICHAEL J. STRIKER, 103 EAST NECK ROAD, HUNTINGTON, NY, 11743, US

(21) Appl. No.: 12/608,210

(22) Filed: Oct. 29, 2009

(30) Foreign Application Priority Data
Oct. 31, 2008 (DE) 10 2008 054 148.6

(51) Int. Cl. C01F 11/22; G01T 1/10

(52) U.S. Cl. 423/490; 250/459.1

(57) ABSTRACT

A method of selecting suitable laser-stable optical material for making an optical element, especially for transmission at wavelengths under 200 nm, is described. It includes a first pre-irradiation to produce radiation damage, subsequent excitation of induced fluorescence with light at between 350 to 700 nm at least ten minutes after the first pre-irradiation and measurement of induced fluorescence intensities at one or more wavelengths between 550 nm and 810 nm. After the fluorescence intensity measurement a second pre-irradiation is performed with an at least 1000-fold higher energy than in the first pre-irradiation and then induced fluorescence intensities are again measured to determine the increase in the fluorescence intensities. The materials determined to have suitable laser stability are used for making lenses, prisms, light-conducting rods, optical windows and optical devices for DUV lithography, especially steppers and excimer lasers, integrated circuits, computer chips as well as other electronic devices.

### CROSS-REFERENCE

The invention claimed and described herein below is also described in German Patent Application DE 10 2008 054 148.6, filed Oct. 31, 2008 in Germany. The aforesaid German Patent Application provides the basis for a claim of priority for the instant invention under 35 U.S.C. 119 (a)-(d).

### BACKGROUND OF THE INVENTION

1. Field of the Invention

The present invention relates to a method of evaluating suitable optical material for making optical elements for high-energy radiation, especially with a wavelength under 200 nm, and to the optical material obtained with this method and their uses.

2. Description of the Related Art

It is known that materials from which optical elements are made absorb more or less of the light or radiation that passes through them, so that the intensity of the light and/or the radiation is generally less after passing through an optical element than before passing through it. It is also known that the extent of the absorption depends on the wavelength of the light. The absorption in optical systems, i.e. optically transparent systems, is kept as small as possible, because these systems should have a high light permeability or transmission, at least at their respective working wavelengths. The absorption is composed of absorption from material-specific components (intrinsic absorption) and those components, which are referred to as the so-called non-intrinsic components, such as inclusions, impurities, and/or crystal defects. While the intrinsic absorption is independent of the respective quality of the material, the additional non-intrinsic components of the absorption lead to a loss of quality of the optical material.

Energy that leads to heating is absorbed by the optical material both by intrinsic and also by non-intrinsic absorption. This sort of heating of the optical material has the disadvantage that the optical properties, such as the index of refraction, change, which leads to a change in the imaging behavior in an optical component used for beam formation, since the index of refraction not only depends on the wavelength of the light but also on the temperature of the optical material. Moreover heating of an optical component leads to a change of the lens geometry. This phenomenon produces a change of the lens focal point or to blurring of the image projected with the heated lens. This leads, especially in photolithography, which is used for making computer chips and electronic circuits, to a quality impairment or to an increase in the number of rejects. That is clearly undesirable.

Furthermore it has been shown that the absorption of the material increases with time with longer irradiation with high-energy light. This effect called radiation damage is composed of a more rapidly occurring reversible component and a slower irreversible component. In the case of the more rapid radiation damage a part of the absorbed radiation is not only converted into heat, but is output again in the form of fluorescence. The formation of fluorescence in an optical material, especially in optical crystals, is known in itself. For example, the production and measurement of laser-induced fluorescence (LIF) in quartz, especially in OH-rich quartz, is described in W. Triebel, Bark-Zollmann, C. Muehlig, et al, “Evaluation of Fused Silica for DUV Laser Applications by Short Time Diagnostics”, Proceedings SPIE Vol. 4103, pp 1-11, 2000. Fluorescence and transmission properties of CaF₂ are described in C. Muehlig, W. Triebel, Toepfer, et al, Proceedings SPIE Vol. 4932, pp. 458-466. The formation of optical absorption bands in a calcium fluoride crystal is described by M. Mizuguchi, et al, in J. Vac. Sci. Technol. A., Vol. 16, pp. 2052-3057 (1998). A time-resolved photoluminescence for diagnosis of laser damage in a calcium fluoride crystal is described by M. Mizuguchi, et al, in J. Opt. Soc. Am. B, Vol. 16, pp. 1153-1159; July 1999. The formation of photoluminescence-forming color centers by excitation with an ArF excimer laser at 193 nm is described there. However so that these sorts of measurements were possible, crystals with a relatively high impurity level were used, which do not satisfy the high standards for photolithography. Furthermore the fluorescence measurement is performed during a time interval of 50 nsec and after the laser pulse has finished passing through the sample. It has now been shown that the fluorescence values so obtained may not be used for quality control or for determination of the extent of impurity formation and thus for formation of color centers in crystals of high quality.

Since manufacture of an entire optical component from an optical blank is very expensive and labor-intensive, there is already a need to establish the extent and nature of the radiation damage that would arise in the optical component during later usage at an earlier time point, i.e. prior to working the blank. Unsuitable material must be discarded. Attempts have already been made to determine the extent and the nature of the radiation damage of this sort by means of laser-induced fluorescence. Thus, for example, WO 2004/027395 describes a process for determination of the non-intrinsic fluorescence in an optical material. In this process the fluorescence in the optical material is directly determined with the same laser, with which the pre-irradiation is performed, i.e. immediately after a pre-irradiation with light at an excitation wavelength of 193 nm or 157 nm.

A method for quantitative determination of the suitability of optical materials is described in DE 103 35 457 A1. In this method the energy-density-dependent transmission is measured at wavelengths in the UV by determining an equilibrium value for the transmission at different fluences, measuring the slope of the curve dT/dH for this sample and comparing with the fluorescence properties.

Since the load on optical elements from lasers in computer lithography is increasing, EP 1 890 131 A2 describes an improved method for determining the long duration laser stability based on changes in the fluorescence excited in a wavelength range of 350 to 700 nm that still occur after the end of the pre-irradiation. In that determination a first measurement is performed immediately after the pre-irradiation and then a second measurement is performed after a predetermined waiting time so that the increase in the fluorescence intensities can be determined after the end of the pre-irradiation.

The above-described EP 1 890 131 A2 teaches that energy deposited in the material after irradiation with high energy light leads to the formation of new sodium-stabilized F-centers that were not present in the crystal prior to the irradiation. These sodium-stabilized F-centers may be excited by further irradiation with light of other wavelengths and then make a transition to their ground state by fluorescence emission.

Correspondingly it was found that these sodium-stabilized F-centers have an extraordinarily long formation time constant (k=1/τ with τ≧10 min), which leads to an increase in the fluorescence intensities up to at least 10 minutes, especially up to at least 20 minutes, and preferably up to at least 30 minutes after the irradiation.

Energetic radiation, such as X-ray radiation, neutron radiation, or energetic laser radiation, is used for producing radiation damage (rapid damage) in the material. The irradiation is preferably performed for a sufficient time until a sufficient number of the F-centers are formed, which is reached at the latest when the equilibrium value of the transmission is reached. This usually is reached after firing about 10,000 pulses of an Ar—F laser (10 mJ/cm²) into the material. The equilibrium value of the transmission is reached when the transmission no longer measurably changes during the irradiation. The equilibrium value is reached with less than 3000 pulses with an energy density greater than 10 mJ/cm².

However it has been shown that when ever higher energies are used those samples, which were determined to have laser stability by the methods of the prior art, do not have sufficient service life and develop radiation damage when they are used in e.g. computer lithography. This problem arises because, among other things, the measurement of fluorescence intensities with a CCD camera in a range of 100 counts or less has errors of about 20 counts (background noise) so that values between 0 and 40 counts cannot be distinguished from each other.

### SUMMARY OF THE INVENTION

It is an object of the present invention to further improve the current method for evaluating laser-stable materials and to provide a method with which materials, especially laser-stable materials, can be rated in regard to laser stability and distinguished from each other.

It is also an object of the present invention to provide an improved method for selecting optical materials for computer lithography, which have improved long duration laser stability to radiation damage caused by energetic laser radiation.

These objects and others, which will be made more apparent hereinafter, are attained by the method defined in the appended claims.

According to the invention it was found that the induced fluorescence produced according to the state of the art by generating radiation damage by pre-irradiating (first pre-irradiation) may be increased many times, when before, after or instead of the prior art pre-irradiation, a pre-irradiation occurs with an especially greater energy than in the prior art method, preferably over a longer time interval. This is all the more surprising, since it is known from the prior art, that an equilibrium is produced after a comparatively short acting time, which is attained after less than 3000 laser pulses, so that the transmission no longer changes during irradiation and the equilibrium is formed again reversible at smaller energy densities. This means that an increase of the sodium-stabilized F-centers by further irradiation could not be expected. However more recently it has been shown that additional defect centers are formed with the high energy irradiation according to the invention, which cannot be formed again with small energy densities. The laser-induced fluorescence (LIF), especially the red LIF, is then greatly increased and this LIF is correlated with an absorption change with long duration irradiation. The intensity of the laser-induced fluorescence, especially the red LIF (RLIF) in samples, which previously had intensities between 0 and 45 counts, now had values between 45 and 800 when the method according to the present invention was performed. This shows that there is a significant increase of the measured induced fluorescence signals due to the production of the additional defects. In this way extremely laser-stable samples of the material, which have intensities of RLIF of less than 150 counts induced by the irradiation of the present invention, can be identified and evaluated from a group of samples that were determined to be laser-stable with RLIF intensities of less than 40 counts by the prior art method.

The first irradiation is typically performed with an energetic radiation until sufficient sodium-stabilized F-centers are formed, which is achieved at the latest with the attainment of equilibrium values of the transmission (constant transmission), but preferably up to the achievement of at least 90%, especially 95%, and particularly preferably 97% of the equilibrium values of the transmission. Typical values and prerequisites for this first irradiation are described for example in EP 1 890 131 A2.

For the second pre-irradiation at the comparatively greater energies the energy input to the optical material is at least 1000 times greater than the energy required to produce an equilibrium concentration of the sodium-stabilized F-centers. Preferably the optical material is irradiated with from 2000 times and/or 3000 times that energy amount. Preferred input energy amounts, which are input to the optical material to be tested during the second pre-irradiation, e.g. amount to at least 5×10⁹ mJ²/cm⁴. This amount of input energy is given by the square of the laser beam energy density multiplied by the number of input laser pulses. Typical energy densities are e.g. at least 10 mJ/cm² but 30 and especially 40 mJ/cm² are preferred. For parallel laser beams the appropriate maximum energy density input with a laser amounts to especially 150 mJ/cm², but 120 and/or 100 mJ/cm² are especially preferred. Typical maximum energy densities amount to 80 mJ/cm², especially 70 mJ/cm², but 65 and/or 60 mJ/cm² are particularly preferred.

With focused laser beams energy densities of 500 or even 1000 mJ/cm² can be attained, which amount to an energy input of 10¹³ mJ²/cm⁴. In this manner particularly strong effects can be attained in a volume.

Typical acting times for the high energy irradiation (second irradiation) amount to at least 5×10⁵ pulses, preferably 1×10⁶ pulses, but a minimum pulse number of 2 and/or 3×10⁶ is especially preferred. Of course the maximum pulse input is not limited but a maximum pulse number of 10⁸ and/or 5×10⁷ has proven to be appropriate to provide an economical method. Especially 10⁷ is preferable as the maximum number of pulses. The pulse number can be less with higher energy densities than with lower energy densities.

The typical energy input for the further and/or second pre-irradiation amounts preferably to at least 10×10⁹ mJ²/cm⁴ and/or 12×10⁹ mJ²/cm⁴. Energy amount of at least 10×10⁹ mJ²/cm⁴ and/or 12×10⁹ mJ²/cm⁴ are especially preferred. The laser light used for this purpose preferably has a wavelength of 150 to 240 nm. An ArF excimer laser with a wavelength of 193 nm is especially preferred.

Suitable radiation sources for performing the induced absorption according to the invention are X-ray sources and other sources the produce energetic radiation, for example neutron beams, radioactive radiation, gamma radiation, e.g. from a Co⁶⁰ source. However X-radiation is especially suitable for the method according to the invention because of its easy availability, low cost and ease of handling.

The energy density required for performing the method according to the invention is variable over a wide range and depends only on the time interval in which saturation is reached. Usually however energy densities of from 10³ to 10⁵ Gy, preferably from 5×10³ to 5×10⁴ Gy are used. The irradiation time required to reach saturation usually is from 10 to 360 minutes, preferably from 30 to 180 minutes. For control of the saturation a second irradiation of the sample can be performed and the intensity of the absorption bands and/or the absorption spectrum can be compared with each other. The desired saturation condition has been reached by the irradiation when there is no change in the intensities of the absorption bands.

In order to guarantee that all color centers in the crystal are excited, the thickness of the irradiated crystal and/or sample should not be too large, since with larger thicknesses uniform penetration of the entire material which depends on the beam resistance of the sample cannot be guaranteed and the greatest portion of the incident radiation is possibly absorbed already in the first part of the of the beam path through the sample. This would lead to different amounts of color centers near the surface through which the beam enters the sample and in the interior of the sample spaced from that surface.

After finishing the first pre-irradiation a pre-test measurement of the fluorescence occurs immediately after the pre-irradiation. This measurement is typically performed 3 to 5 seconds after the end of the irradiation and usually lasts for one second. At least 10 minutes, preferably at least 20 minutes, is expected between the irradiation and the first measurement of the fluorescence (equal measuring times). In individual cases it has proven suitable to wait at least 30 minutes and even at least 50 minutes. However it has been shown that the first measurement of the fluorescence should not occur later than 15 hours, especially not later than 10 hours, after the end of the pre-irradiation, since then the effects of relaxation processes become noticeable, which makes the measurement results erroneous. Thus these measurements are typically not performed later than eight hours are the end of the respective pre-irradiation.

It has been shown that a second high energy pre-irradiation according to the method of the present invention produces a significant laser-induced fluorescence (LIF) even in those samples previously designated as laser-stable according to the prior art test or selection method. By means of the further energetic pre-irradiation according to the invention an increase in the sensitivity of at least a factor of 10, especially at least a 20-fold increase, is possible in contrast to the induced fluorescence detection described in EP 1 890 131 A2. An increase of the sensitivity by a factor of 30 and/or 40 has proven to be possible in many cases.

According to the invention it is preferred to first determine the laser-stable samples with the method described in EP 1 890 131 A2 and to detect those samples from the group of samples determined to be laser-stable by the method of the prior art, that are especially laser-stable according to the present method. The especially laser-stable samples exhibit only a slight change of their induced fluorescence from that produced by the first pre-irradiation when pre-irradiated for a second time after the first measurement of induced fluorescent intensity with the higher energy radiation. For this measurement the fluorescence bands at 630 nm and 740 nm are especially preferred.

The method according to the invention is preferably used to test samples of alkali halides and alkaline earth halides. Calcium fluoride, barium fluoride, strontium fluoride, lithium fluoride, potassium fluoride, sodium fluoride and mixtures such as KMgF₃ are particularly preferred.

Special laser-stable optical material, especially the aforesaid alkali halides and alkaline earth halides, which are selected with the method as defined in the appended claims, are also a part or another aspect of the present invention.

With the test method according to the present invention it is even possible to test non-crystalline precursors, such as the calcium fluoride ingots described in DE 10 2004 003829, prior to their growth to form large-volume single crystals for their laser beam resistance during later laser applications. It is thus possible to evaluate and/or select suitable single crystals prior to their expensive growth from the precursor materials.

The optical material that has sufficient laser-stability according to the method of the present invention is especially suitable for making optical components for DUV lithography, and for making wafers coated with photo lacquer and thus for making electronic devices. The invention thus also concerns the use of materials selected or obtained by the method according to the invention and/or crystals according to the invention for making lenses, prisms, light conducting rods, optical windows and optical devices for DUV lithography, especially for making steppers and excimer lasers and thus also for making of integrated circuits, computer chips and electronic devices, such as processors and other device, which contain chip-type integrated circuits.

Laser-stable material can be already evaluated at an early stage in the manufacturing process by means of the aforesaid method. Photolithographic illumination devices, lasers used in them and/or laser beam guidance systems currently in development require materials that are especially laser-stable. These requirements result from the productivity demands on this sort of equipment, which increase laser power and with that energy density requirements. The sensitivity of the aforesaid short duration measurement methods for pre-evaluating suitable optical raw material are thus no longer sufficient to distinguish especially laser-stable samples from a group of laser-stable samples.

The fluorescence is excited with excitation radiation with wavelengths between 460 and 700 nm, especially between 500 and 650 nm, wherein excitation radiation with wavelengths between 530 and 635 is especially preferred. Excitation radiation with wavelengths of 532, 633 and 635 nm is particularly especially preferred. Furthermore if the excitation radiation has wavelengths below 600 nm a fluorescence band at 630 nm is observable.

Excitation of fluorescence with a helium-neon laser at 633 nm or with a laser diode at 635 nm (both red laser beam, RLIF) or at 532 nm with a fiber optic laser pumped with a diode (DPSS laser, green laser, GLIF) has proven especially suitable. The excitation with the helium-neon laser at 633 nm or with the laser diode at 635 nm is a factor of four times more sensitive than the excitation at 532 nm. Primarily the fluorescence intensity signal depends approximately linearly on the incident laser power.

The especially laser-stable material does not change its induced fluorescence or only changes it slightly after the second pre-irradiation in comparison the induced fluorescence after the first pre-irradiation.

Both fluorescence bands within a wavelength range of 550 nm to 810 nm are suitable for fluorescence intensity measurements. However in the case of calcium fluoride a wavelength of 740 nm has proven to be especially suitable.

In contrast to a laser-stable sample an especially laser-stable sample to be evaluated or selected according to the method of the present invention has only a slight increase of the respective fluorescence intensities of the bands at 630 nm and 740 nm in comparison to the fluorescence intensities of those bands measured under the same conditions during the first measurement of induced fluorescence intensities.

In a suitable embodiment of the method of the present invention the respective measured fluorescence intensities of a sample to be evaluated are compared with those of a comparison sample with suitable laser stability for the planed application. Both samples are tested under the same conditions, i.e. with the same wavelengths and the same input energy densities. A sample is used as the comparison sample, which has a fluorescence band at 740 nm still in the background noise of the measuring equipment immediately after the pre-irradiation in a fluorescence measurement according to the state of the art at 193 nm. For this purpose the laser beam resistance was determined under the usage conditions, for example with the aforesaid pulse duration for the energetic radiation.

The method according to the invention is also employed in order to determine the laser beam resistance of samples, in which no band at 740 nm is detectable or is still in the background noise of the apparatus after the pre-irradiation at 193 nm in the fluorescence measurement method according to the prior art and detection of laser-stable and especially laser-stable samples in a group of samples is not possible by the single stage measurement method of the prior art. The method according to the invention is needed when a fluorescence peak of ≦40 counts, especially ≦20 counts, is detected according to the prior art method. The method according to the invention is especially preferred when the fluorescence peak intensity is less than or equal to 15 counts, which corresponds to the measurement error.

### BRIEF DESCRIPTION OF THE DRAWING

The objects, features and advantages of the invention will now be illustrated in more detail with the aid of the following examples, with reference to the accompanying figures in which:

FIG. 1 is a graphical illustration showing the increase of induced fluorescence signals of individual more or less laser-stable samples of optical material after irradiation with a pulsed laser;

FIG. 2 is a graphical illustration showing the increase in the induced fluorescence signals of individual samples after irradiation with X-ray radiation; and

FIG. 3 is a graphical showing the induced fluorescence signals of especially laser-stable samples of the optical material, which cannot be differentiated from each other using the red laser-induced fluorescence measurements of the prior art but can be distinguished from each other by the method according to the present invention.

### EXAMPLES

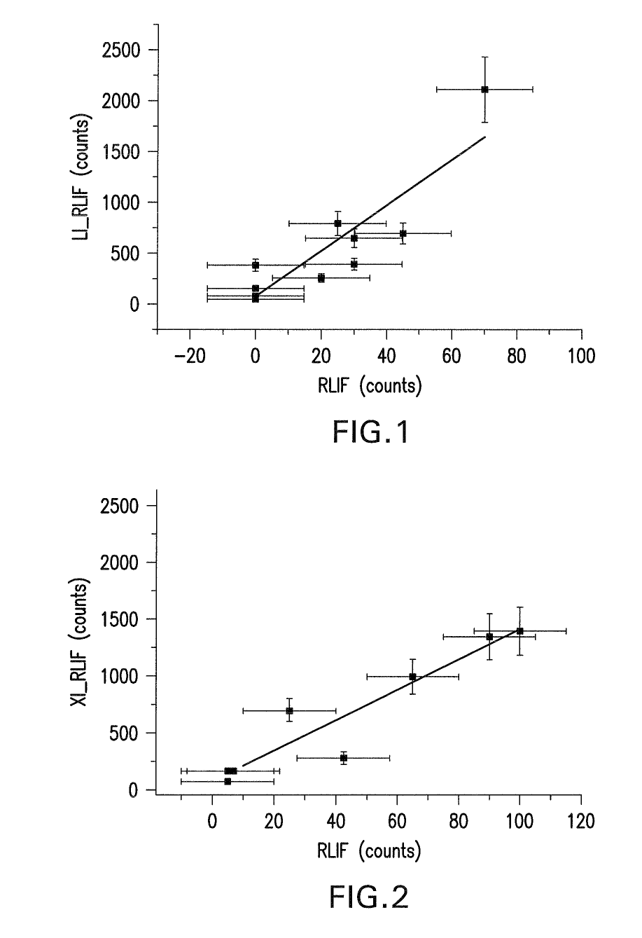

Different calcium fluoride crystals described by EP 1 890 131 A2 as laser-stable or laser radiation resistant were irradiated with 25 million pulses of 50 mJ/cm² from a pulsed laser and subsequently the laser-induced fluorescence signals were measured with a CCD camera by the same measurement methods as previously in the first measurement of induced fluorescence. The results are shown in FIG. 1.

The light induced fluorescence signal prior to the energetic irradiation is plotted in FIG. 1 against the induced fluorescence signal after the extremely energetic irradiation. As can be ascertained from FIG. 1 the five samples according to the prior art method that had hardly any induced fluorescence had an induced fluorescence of between about 100 and 400 counts. One sample, which only had about 20 counts when exposed to a conventional irradiation, had an induced fluorescence of about 260 counts. This shows that the improved method for selecting optical material according to the present invention has a significantly greater reliability than the prior art method.

In a further experiment samples, which were irradiated according to the prior art methods, were subjected to an irradiation with X-rays with an X-ray apparatus with X-rays of 160 kV/18.5 mA. Each crystal was irradiated with a spacing of 18 cm at 240 Sv/h for 100 minutes. These samples, which previously had barely observable laser induced fluorescence of about 5, now had a fluorescence of about 100 to 200 counts as shown in FIG. 2. This also means that the method according to the present invention has a significantly increased sensitivity in relation to the prior art method.

With the method according to the prior art, which is the method described in EP 1 890 131 A2, samples that had hardly any induced fluorescence signal, like those described in relation to FIG. 1, were subjected to a second laser irradiation with higher energy. Those samples, which up to now did not exhibit fluorescence, had developed a very easily measurable laser-induced fluorescence in the red range of the spectrum at 740 nm.

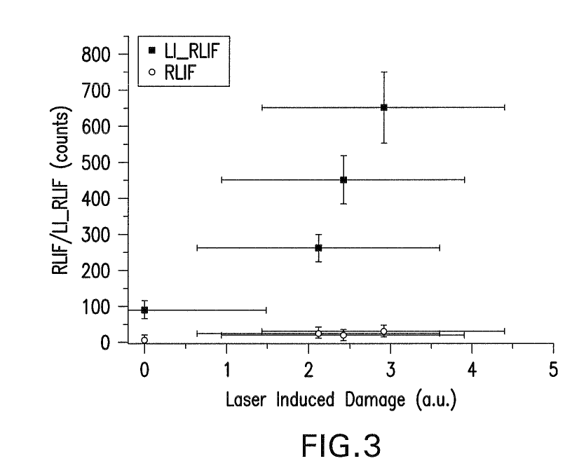

FIG. 3 illustrates the increased sensitivity of the method according to the invention. Four samples, which did not appear to have different induced fluorescence signals according to the prior art method, now exhibited were easily distinguishable from each other and could be ranked according to the strength of their induced fluorescence signal. The points designated “RLIF” are the induced fluorescence signals measured with the prior art method, whereas the points designated “LI-RLIF” are the induced fluorescence signals measured according to the method of the present invention.

While the invention has been illustrated and described as embodied in a method of determining laser stability of optical material, crystals obtained with the method, and uses of the crystals, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A method of selecting especially laser-stable optical material for making optical elements, especially for transmission of high-energy electromagnetic radiation with wavelengths under 200 nm, said method comprising the steps of:
a) performing a first pre-irradiation of an optical material to produce radiation damage;
b) after performing the first pre-irradiation, exciting an induced fluorescence in said optical material with light of a wavelength between 350 to 700 nm at least ten minutes after an end of said first pre-irradiation;
c) measuring intensities of said induced fluorescence at one or more wavelengths between 550 nm and 810 nm;
d) after the measuring of said induced fluorescence intensities in step c), performing a second pre-irradiation of said optical material with an at least 1000-fold higher energy than in said first pre-irradiation; and
e) subsequent to said second pre-irradiation of step d), measuring intensities of said induced fluorescence a second time and then determining an increase of said intensities of said induced fluorescence.

2. The method as defined in claim 1, wherein said wavelength that excites said induced fluorescence in said optical material is between 350 nm and 430 nm or between 500 nm and 700 nm.

3. The method as defined in claim 1, wherein said first pre-irradiation of said optical material is performed by a laser with laser radiation in a wavelength range from 150 nm to 240 nm.

4. The method as defined in claim 3, wherein said laser is an ArF excimer laser and said laser radiation is at 193 nm.

5. The method as defined in claim 1, wherein said wavelengths at which said intensities of said induced fluorescence are measured are between 580 nm and 810 nm and/or between 680 nm and 810 nm.

6. The method as defined in claim 1, wherein said induced fluorescence intensities are measured at a first time immediately after said end of said first pre-irradiation and/or immediately after said end of said second pre-irradiation and said induced fluorescence intensities are also measured at a second time after waiting for at least 5 minutes and at most 15 hours after said end of said first pre-irradiation and/or after said end of said second pre-irradiation.

7. The method as defined in claim 1, wherein said optical material is a CaF₂ crystal.

8. The method as defined in claim 1, wherein said second pre-irradiation is performed with laser radiation with an energy of at least 5×10⁹ mJ²/cm⁴, with X-radiation with an energy of at least 500 Ws/mm², or gamma radiation or another radiation equivalent to said gamma radiation with an energy of at least 10³ Gy.

9. A lens, a prism, a light conducting rod, an optical window, an optical device for DUV lithography, a stepper for DUV lithography, an excimer laser for DUV lithography, an integrated circuit, a computer chip, an electronic device, or a processor, which comprises an optical material that is selectable by the method as defined in claim 8.

10. A lens, a prism, a light conducting rod, an optical window, an optical device for DUV lithography, a stepper for DUV lithography, an excimer laser for DUV lithography, an integrated circuit, a computer chip, an electronic device, or a processor, which comprises an optical material that is selectable with the method as defined in claim 1.
